(19) United States
(12) Patent Application Publication
(10) Pub. No.: US 2004/0074691 A1
(43) Pub. Date: Apr. 22, 2004

(54) Virtual braking system for hydrostatically driven vehicle

(76) Inventors: Joel Bombardier, Magog (CA); Andre Todd, Laprairie (CA)

Correspondence Address: PILLSBURY WINTHROP, LLP, P.O. BOX 10500, MCLEAN, VA, 22102, US

(21) Appl. No.: 10/450,160

(22) PCT Filed: Dec. 6, 2001
(86) PCT No.: PCT/CA01/01747

(51) Int. Cl. B60K 17/00

(52) U.S. Cl. 180/307

(57) ABSTRACT

A hydrostatic vehicle drive system features a “virtual” braking system designed to emulate the braking response of a mechanically driven vehicle equipped with an automatic transmission and disk or drum brakes. A microprocessor controls output of the pumps used to power the hydraulic motors, and causes the power output to decrease independently and gradually according to a declaration ramp, rather instantaneously with changes in fuel pedal position.

### FIELD OF TIE INVENTION

The invention relates in general to a “virtal” braking system for a hydrostatically driven vehicle and, more particularly, to a virtual braking system for a hydrostatically, track-driven vehicle such as a snow plow or snow groomer.

### BACKGROUND OF TE INVENTION

In a hydrostatically driven vehicle, motive power is generated by means of one or more hydrostatic motors in which a power output shaft is caused to rotate by pumping hydraulic fluid, e.g., hydrostatic oil, through the motor. An engine, e.g., a diesel engine, typically drives the variable displacement pump or pumps used to circulate the hydraulic fluid, and the rate of flow through a given hydrostatic motor (and hence the power output from the hydrostatic motor) may be controlled by means of a valve.

Hydrostatic drive systems have been used in vehicles such as utility vehicles, e.g., sidewalk- or parking lot-clearing snow plows, for their flexibility and infinitely variable speed Such vehicles often have a pair of independent, propulsion-providing track systems, with one on either side of the vehicle. Each independent track system has its own power-providing hydrostatic motor and associated variable displacement, hydraulic fluid pump; both pumps may be powered by the same engine.

In these known vehicles, vehicle speed is directly controlled by the position of a throttle pedal. In particular, a sensor such as a potentiometer measures the position of the throttle pedal and sends a signal to an on-board microprocessor. The microprocessor then controls the speed of each hydrostatic motor by proportionally “stroking” the associated variable displacement pump, thereby regulating the flow of hydraulic fluid through the hydrostatic motor.

Vehicle direction is controlled by the position of the steering wheel. A sensor, e.g., a potentiometer, measures steering wheel position to determine steering command inputs. The microprocessor receives such steering command input information and differentially controls the power output of each hydrostatic motor by differentially controlling each motor's associated pump, thereby effecting differential drive speed of each track system and hence turning movement of the vehicle.

In these known vehicles, the power output of the hydrostatic motor, and hence the speed of the vehicle, is directly proportional to the position of the throttle pedal (speed command input). Therefore, a “lighter,” more sensitive “touch” on the throttle pedal is required to avoid uncomfortable, “jerking” motion of the vehicle. Additionally, if the operator releases the throttle pedal all of a sudden, e.g., if his or her foot slips off of the throttle pedal or in a panic braking situation, the vehicle will come to a complete stop virtually instantaneously.

### SUMMARY OF THE INVENTION

The present invention provides a “virtual” braking system for a hydrostatically driven vehicle which allows the hydrostatically driven vehicle to perform more like a mechanically driven vehicle equipped with an automatic transmission (with disk or drum brakes), thereby eliminating these uncomfortable deficiencies of prior art vehicles. The invention accomplishes this by using the on-board microprocessor to “ramp” the hydrostatic motor output speed down gradually, e.g., by varying pump output over a period of time. Such variation in pump output may be effected by time-varying the pump output control valve position. The precise rate at which hydrostatic motor output (i.e., pump output) decreases is controlled in a manner that is not directly proportional to (e.g., independently of) the rate of change of throttle pedal position during deceleration of the vehicle. Additionally, hydrostatic motor output may be varied based on the position of a separate brake pedal.

### BRIEF DESCRIPTION OF THE DRAWINGS

These and other features and advantages of the invention will become clear in view of the detailed description of preferred embodiments and the figures, in which:

FIG. 1 is a schematic illustration of a hydrostatic drive system according to the invention; and

FIG. 2 illustrates various deceleration curves associated with the hydrostatic drive system illustrated in FIG. 1.

### DETAILED DESCRIPTION OF THE PREFERRED EMBODIMENTS OF THE INVENTION

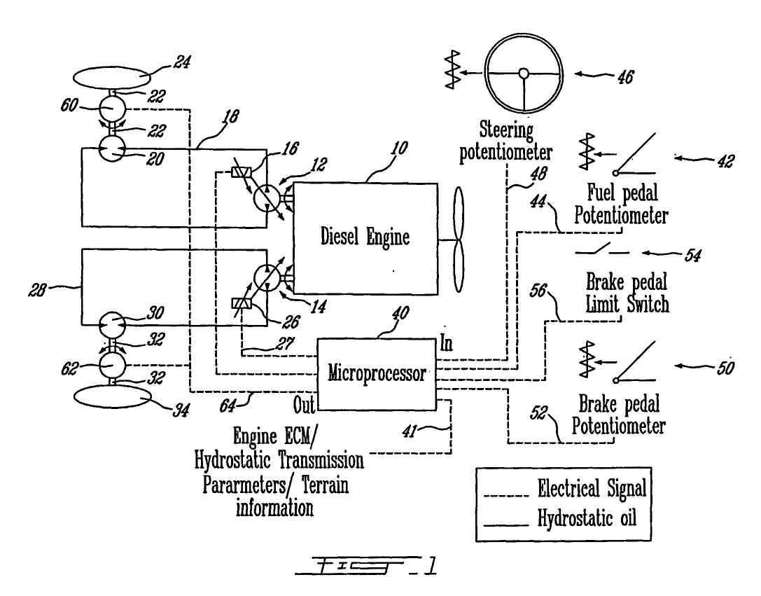

FIG. 1 illustrates the drive system of a differentially driven, hydrostatically driven vehicle (e.g., a track-driven snow plow) having a virtual braking system according to the invention. The vehicle (not illustrated specifically) has a diesel engine 10 which drives the left hand drive pump 12 and the right hand drive pump 14. Left hand pump valve 16 regulates the flow of hydraulic fluid (e.g., hydrostatic oil) through left hand hydraulic circuit 18 and hence through left hand hydraulic motor 20. Thus, the left hand pump valve 16 regulates the speed at which the left hand power output shaft 22 rotates; the rate at which left hand drive sprocket or wheel 24 rotates; and therefore the rate at which the left hand propulsion assembly (not shown), e.g., a series of wheels or a track system, moves.

Similarly, right hand pump valve 26 regulates the flow of hydraulic fluid through right hand hydraulic circuit 28 and hence through right hand hydraulic motor 30. Thus, right hand pump valve 26 regulates the rate at which right hand power output shaft 32 rotates; the rate at which right hand drive sprocket or wheel 34 rotates; and therefore the rate at which the right hand propulsion assembly (not shown) moves.

The drive system is governed or controlled by a microprocessor 40. A sensor (not shown explicitly), e.g., a potentiometer, determines the position of the vehicle fuel pedal 42 and provides that information to the microprocessor 40 via signal line 44. Additionally, a sensor (not explicitly shown), e.g., a potentiometer, determines the position of the vehicle steering wheel 46 and provides that information to the microprocessor 40 via signal line 48.

As further indicated in FIG. 1, hydrostatic engine speed (revolutions per minute), hydrostatic engine system pressure, and terrain information (i.e., slope or grade of the ground on which the vehicle is travelling) are determined by appropriate sensors (not shown but known to those having skill in the art), and that information is also provided to the microprocessor 40 via signal line 41. The microprocessor 40 uses this information to control the output of the left hand drive pump 12 and the right hand drive pump 14 (via the left hand pump valve 16 and the right hand pump valve 26, respectively) so as to produce the desired forward speed and turning rate corresponding to the position of the fuel pedal 42 and steering wheel 46, respectively. It will be appreciated that turning is effected by controlling the left hand drive pump 12 and right hand drive pump 14 so as to cause the left hand hydraulic motor 20 and the right hand hydraulic motor 30 to operate at different speeds, the size of the differential and the order of the differential (right greater than left or left greater than right) being determined by the steering wheel position.

In addition to the fuel pedal 42, the system includes a brake pedal 50. A sensor (not specifically shown), e.g., a potentiometer, determines the position of the brake pedal 50 and provides this information to the microprocessor 40 via signal line 52. The system further includes a brake pedal limit switch 54 which closes when the brake pedal 50 is depressed completely, e.g., when the operator is making a “panic stop.” The microprocessor 40 receives limit switch closure status information via signal line 56.

With the drive system of the invention, the microprocessor 40 controls positive acceleration of the vehicle in generally the same manner as in the prior art In particular, depressing the throttle pedal 42 more fully increases engine revolutions per minute (rpm) and hence increases the speed at which the diesel engine 10 drives the left hand variable displacement drive pump 12 and the right hand variable displacement drive pump 14. The microprocessor 40 sends a corresponding signal to the left hand pump valve 16 via signal line 17 and a corresponding signal to the right hand pump valve 26 via signal line 27. The left hand pump valve 16 and right hand pump valve 26 respond accordingly, allowing more hydraulic oil to circulate within the left hand hydraulic circuit 18 and right hand hydraulic circuit 28, respectively, thereby increasing vehicle speed.

Negative acceleration (“deceleration”) of the vehicle, on the other hand, is controlled in a novel manner. Whereas in the prior art the hydraulic motor speed is directly related to the position of the fuel pedal during deceleration, such that suddenly releasing the fuel pedal would cause the vehicle to stop suddenly (or a sudden, less than total decrease in the amount by which the fuel pedal is depressed would result in a corresponding sudden decrease in vehicle speed), the present invention eliminates such sudden decreases in vehicle speed. In particular, rather than commanding the left hand pump valve 16 and the right hand pump valve 26 immediately to positions corresponding to a reduced amount by which the fuel pedal 42 may be depressed (reduced speed command input), the microprocessor 40 causes the positions of the left hand pump valve 16 and the right hand pump valve 26 to change gradually such that the speed of the vehicle decreases gradually, i.e., not directly proportionally to (e.g., independently of) the rate of change in the position of the fuel pedal.

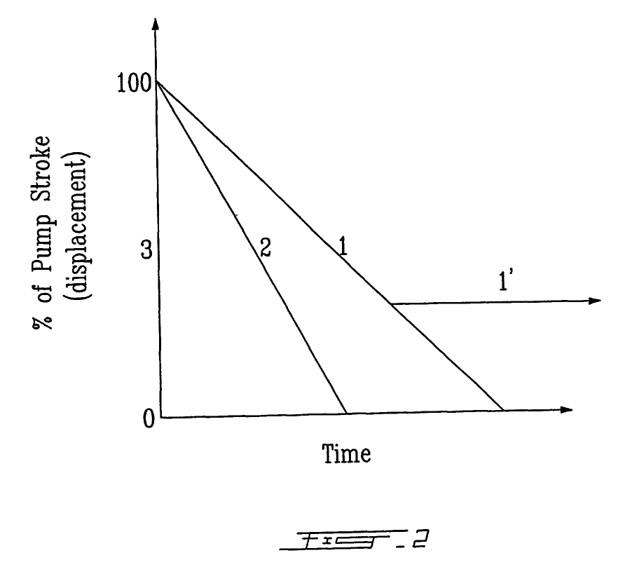

Thus, when the operator lifts his or her foot such that the fuel pedal 42 comes to a less depressed position, the microprocessor 40 controls the position of the left hand pump valve 16 and the right hand pump valve 26 such that the pump stroke of each of the left hand drive pump 12 and the right hand drive pump 14 decreases gradually, as illustrated, for example, by deceleration ramp 1 in FIG. 2. If the operator entirely removes his or her foot from the fuel pedal 42, the microprocessor 40 controls the output of the left hand drive pump 12 and the right hand drive pump 14 such that the respective outputs decrease until there is no more circulation of fluid in the left hand hydraulic circuit 18 or in the right hand hydraulic circuit 28, and the vehicle comes to a stop. If the operator simply decreases the amount by which the fuel pedal 42 is depressed, however, but maintains some degree of depression of the fuel pedal 42, the microprocessor 40 reduces the output of the left hand drive pump 12 and the right hand drive pump 14 until the respective outputs correspond to the new position of the fuel pedal 42, and the pumps continue to provide output at a constant rate (assuming the pedal position is maintained) as exemplified by the horizontal line 1′ in FIG. 2.

If the operator wants to slow the vehicle more quickly, he or she depresses the brake pedal 50. The microprocessor 40 receives information as to the position of the brake pedal 50 via signal line 52 and increases the negative slope of the deceleration curve accordingly. For example, if the brake pedal 50 is only partially depressed, the microprocessor 40 will control the output of the left hand drive pump 12 and the right hand drive pump 14 such that the pump outputs decrease according to deceleration ramp 2 in FIG. 2 until the vehicle comes to a stop. The slope of the deceleration ramp (i.e., the rate at which pump output is decreased) varies with brake pedal position such that the rate at which the vehicle decelerates increases as the brake pedal 50 is depressed further, and the rate at which the vehicle speed decreases as the brake pedal 50 is gradually released.

The system also includes a brake pedal limit switch 54. In the event of a panic stop, the operator depresses the brake pedal 50 completely, which closes the brake pedal limit switch 54. The microprocessor 40 receives this information via signal line 56 and immediately (or virtually immediately) causes the output of the left hand drive pump 12 and the right hand drive pump 14 to terminate, as illustrated by the essentially vertical deceleration “ramp” 3 in FIG. 2.

Once the output of the left hand drive pump 12 and the right hand drive pump 14 have reached zero, the microprocessor 40 causes mechanical brakes 60 and 62 to engage the left hand power output shaft 22 and the right hand power output shaft 32, respectively, to lock the vehicle in its stationary position. The microprocessor 40 controls engagement of the mechanical brakes 60 and 62 by sending a signal along signal line 64. The mechanical brakes 60 and 62 may also be actuated when the brake pedal limit switch 54 is actuated during a “panic stop.” The mechanical brakes 60 and 62 are released when the fuel pedal 42 is again depressed.

In addition, it will be appreciated that the slope of the deceleration ramp may be slightly different between the left and right drive systems when the vehicle is turning while slowing down. The microprocessor adjusts the deceleration rates of the left and right sides of the system such that, given the differential between the two sides (which is a function of the position of the steering wheel 46), the output of the left hand drive pump 12 and the right hand drive pump 14 will become zero substantially simultaneously. Finally, the drive system of the invention operates equally well when the vehicle is traveling forward or backward; backward travel is effected by reversing the direction of circulation of the hydraulic fluid within the left hand hydraulic circuit 18 and the right hand hydraulic circuit 28.

Although the invention has been described in the context of a dual drive system, tracked vehicle such as a snow plow, it will be appreciated that the invention may be utilized in any hydrostatically driven vehicle, regardless of the number of separate drive systems on the vehicle (e.g., a vehicle having a single, centrally located drive track) or regardless of whether the vehicle is propelled by means of tracks or wheels. These and other modifications to and departures from the disclosed embodiments are deemed to be within the scope of the following claims.

What is claimed is:

1. A drive system for a hydrostatically driven vehicle, comprising:
a hydrostatic motor capable of providing motive power to the vehicle in proportion to a flow rate of hydrostatic fluid through said hydrostatic motor;
a speed command input member capable of generating a speed command input value; and
a controller, in communication with said speed command input member, capable of receiving said speed command input value and regulating said flow rate to control the motive power provided by said hydrostatic motor based on said speed command input value;
wherein said controller regulates said flow rate so that 1) said flow rate is directly proportional to said speed command input value when said speed command input value is in a steady state condition, and 2) in response to a decrease in said speed command input value, said flow rate decreases at a rate that is not directly proportional to the decrease in said speed command input value.

2. The drive system of claim 1, wherein in response to a decrease in said speed command input value, said flow rate decreases at a rate that is independent of the decrease in said speed command input value.

3. The drive system of claim 1, wherein said speed command input member comprises a vehicle fuel pedal and said speed command input value is proportional to a position of said vehicle fuel pedal.

4. The drive system of claim 1, further comprising a braking command input member capable of generating a braking command input value,
wherein said controller, in communication with said braking command input member, receives said braking command input value and modifies the rate at which said flow rate decreases in accordance with said braking command input value.

5. The drive system of claim 4, wherein said braking command input member comprises a vehicle brake pedal and said braking command input value corresponds to a position of said vehicle brake pedal.

6. The drive system of claim 1, further comprising a panic stop command input member capable of generating a panic stop command input,
wherein said controller, in communication with said panic stop command input member, receives said panic stop command input and terminates the flow rate substantially instantaneously.

7. The drive system of claim 6, wherein said panic stop command input member comprises a panic switch.

8. The drive system of claim 7 further comprising a vehicle brake pedal, wherein said panic switch is positioned so as to be actuated upon complete depression of said vehicle brake pedal.

9 The drive system of claim 1, further comprising a pump which causes hydrostatic fluid to circulate through said hydrostatic motor.

10 The drive system of claim 9 wherein said pump is a variable displacement pump and said drive system further comprises a valve which regulates output of said variable displacement pump, said controller regulating said flow rate by controlling a setting of said valve.

11 The drive system of claim 1, wherein the vehicle has two independent propulsion assemblies, said drive system comprising a pair of independent hydrostatic motors and a pair of independent controllers.

12 A hydrostatically driven vehicle, comprising:
a propulsion-providing assembly; and
a drive system operatively connected to the propulsion-providing assembly including:
a hydrostatic motor capable of providing motive power to the propulsion-providing assembly in proportion to a flow rate of hydrostatic fluid through said hydrostatic motor,
a speed command input member capable of generating a speed command input value; and
a controller, in communication with said speed command input member, capable of receiving said speed command input value and regulating said flow rate to control the motive power provided by said hydrostatic motor based on said speed command input value;
wherein said controller regulates said flow rate so that 1) said flow rate is directly proportional to said speed command input value when said speed command input value is it a steady state condition, and 2) in response to a decrease in said speed command input value, said flow rate decreases at a rate that is not directly proportional to the decrease in said speed command input value.

13. The vehicle of claim 12, wherein in response to a decrease in said speed command input value, said flow rate decreases at a rate that is independent of the decrease in said speed command input value.

14. The vehicle of claim 12, wherein said speed command input member comprises a vehicle fuel pedal and said speed command input value is proportional to a position of said vehicle fuel pedal.

15. The vehicle of claim 12, further comprising a braking command input member capable of generating a braking command input value,
wherein said controller, in communication with said braking command input member, receives said braking command input value and modifies the rate at which said flow rate decreases in accordance with said braking command input value.

16. The vehicle of claim 15, wherein said braking command input member comprises a vehicle brake pedal and said braking command input value corresponds to a position of said vehicle brake pedal.

17. The vehicle of claim 12, further comprising a panic stop command input member capable of generating a panic stop command input,
wherein said controller, in communication with said panic stop command input member, receives said panic stop command input and terminates the flow rate substantially instantaneously.

18. The vehicle of claim 17, wherein said panic stop command input member comprises a panic switch.

19. The vehicle of claim 18, further comprising a vehicle brake pedal, wherein said panic switch is positioned so as to be actuated upon complete depression of said vehicle brake pedal.

20. The vehicle of claim 12, further comprising a pump which causes hydrostatic fluid to circulate through said hydrostatic motor.

21. The vehicle of claim 20, wherein said pump is a variable displacement pump and said drive system further comprises a valve which regulates output of said variable displacement pump, said controller regulating said flow rate by controlling a setting of said valve.

22. The vehicle of claim 12, wherein the vehicle has two independent propulsion-providing assemblies, said drive system comprising a pair of independent hydrostatic motors and a pair of independent controllers.

23. A method of operating a hydrostatically driven vehicle, said vehicle comprising a) a hydrostatic motor capable of providing motive power to the vehicle in proportion to a flow rate of hydrostatic fluid through said hydrostatic motor, and b) a speed command input member capable of generating a speed command input value, said method comprising:
regulating said flow rate such that said flow rate is directly proportional to said speed command input value when said speed command input value is in a steady state; and
regulating said flow rate when said speed command input value decreases such that said flow rate decreases at a rate which is not directly proportional to the decrease in said speed command input value.

24. The method of claim 23, wherein when said speed command input value decreases, said flow rate is regulated such that said flow rate decreases at a rate which is independent of the decrease in said speed command input value.

25. The method of claim 23, wherein the vehicle further comprises a braking command input member capable of generating a braking command input value, said method further comprising modifying the rate at which said flow rate decreases in accordance with said braking command input value.

26. The method of claim 23, wherein the vehicle further comprises a panic stop signal generating member capable of generating a panic stop signal, said method further comprising decreasing said flow rate to zero substantially instantaneously upon generation of a panic stop signal.
